(19) United States
(12) Patent Application Publication
(10) Pub. No.: US 2020/0401328 A1
(43) Pub. Date: Dec. 24, 2020

(54) STORAGE DEVICE AND METHOD OF OPERATING THE SAME

(71) Applicant: SK hynix Inc., Icheon-si (KR)

(72) Inventor: Joo Young Lee, Seoul (KR)

(21) Appl. No.: 16/696,764

(22) Filed: Nov. 26, 2019

(30) Foreign Application Priority Data
Jun. 21, 2019 (KR) 10-2019-0073884

(51) Int. Cl. G06F 3/06

(52) U.S. Cl. CPC G06F 3/0631; G06F 3/0679; G06F 3/0604

(57) ABSTRACT

A memory controller for controlling one or more memory devices is provided. The memory controller includes a storage area manager and an operation controller in communication with the storage area manager. The storage area manager is configured to determine a number of super block groups having a predetermined size based on a number of the memory devices connected to the memory controller through a channel, allocate at least one memory device to each of the super block groups, and allocate at least two memory blocks included in the at least one memory device in each of the super block groups as a super block. The operation controller is configured to control the at least one memory device in each of the super block groups to store data in the super block or to read data stored in the super block.

### CROSS-REFERENCE TO RELATED APPLICATION

This patent document claims priority to and benefits of the Korean patent application number 10-2019-0073884, filed on Jun. 21, 2019, which is incorporated herein by reference in its entirety.

### TECHNICAL FIELD

Various implementations of the disclosed technology relate to an electronic device, and more particularly, to a storage device and a method of operating the same.

### BACKGROUND

Storage devices refer to electronic components that are used to store data on a permanent or temporary basis. Each storage device may include one or more storage mediums to store data and may further include a memory controller configured to control the memory device to store or retrieve data. The storage device can be classified based on the type of storage medium. For example, a hard disk drive (HDD) uses a magnetic disk as the storage medium, and a solid-state drive (SSD) or a memory card uses, as the storage medium, semiconductor memory devices such as a volatile memory device and a non-volatile memory device.

The volatile memory device is a device that can retain its data only when power is supplied. Thus, such a volatile memory device loses its data in the absence of power. Examples of the volatile memory device includes a static random access memory (SRAM), a dynamic random access memory (DRAM).

On the other hand, a non-volatile memory device is a device that can retain its data even in the absence of power. Examples of the non-volatile memory device include a read only memory (ROM), a programmable ROM (PROM), an electrically programmable ROM (EPROM), an electrically erasable and programmable ROM (EEPROM), and a flash memory.

### SUMMARY

Various implementations of the disclosed technology relate to a storage device and its operating method, which provide improved capabilities including storage area management.

In one aspect, a memory controller for controlling one or more memory devices is provided. The memory controller includes a storage area manager and an operation controller. The memory controller includes a storage area manager and an operation controller. The storage area manager is configured to determine the number of super block groups having a default size according to the number of the plurality of memory dies commonly connected through a channel, allocate at least one memory die among the plurality of memory dies to each of the super block groups, and allocate at least two memory blocks among the memory blocks included in the memory dies of each super block group among the super block groups as a super block. The operation controller is in communication with the storage area manager and configured to control at least one memory device in each of the super block groups to store data in the super block or to read data stored in the super block.

In another aspect, a storage device is provided to comprise one or more memory devices, each including one or more memory blocks, and a memory controller in communication with the one or more memory devices through a channel. The memory controller is configured to determine a number of super block groups having a predetermined size based on a number of the one or more memory devices, allocate at least one memory die among the plurality of memory dies to each of the super block groups, allocate at least two memory blocks among the memory blocks included in the at least one memory device in each of the super block groups as a super block, and control the memory devices to store data in the super block or to read data stored in the super block.

In another aspect, a method of operating a storage device including one or more memory devices is provided. The method includes determining a number of super block groups having a predetermined size based on a number of memory devices connected to a channel, allocating at least one memory device among the one or more memory devices to each of the super block groups, allocating at least two memory blocks among memory blocks included in the one or more memory devices of each of the super block groups as a super block, and performing a read operation or a write operation on the super block.

The disclosed technology can provide a storage device having improved storage area management performance, and a method of operating the same are provided.

### BRIEF DESCRIPTION OF THE DRAWINGS

FIG. 1 is a diagram illustrating an example of a storage device based on some implementations of the disclosed technology.

FIG. 2 is diagram illustrating an example configuration of a memory device of FIG. 1.

FIG. 3 is a diagram illustrating an example of a memory cell array of FIG. 2.

FIG. 4 is a diagram illustrating an example of a memory controller controlling a plurality of memory devices.

FIG. 5 is a diagram illustrating an example of a super block based on some implementations of the disclosed technology.

FIG. 6 is a diagram illustrating another example of a super block based on some implementations of the disclosed technology.

FIG. 7 is a diagram for describing an example configuration and an example operation of a memory controller based on some implementations of the disclosed technology.

FIG. 8 is a diagram for illustrating an example method of allocating a super block based on some implementations of the disclosed technology.

FIG. 9 is a diagram for illustrating an example method of allocating a super block based on some implementations of the disclosed technology.

FIG. 10 is a diagram for illustrating an example of a bad block management method based on a super block group as shown in FIG. 8.

FIG. 11 is a diagram for illustrating an example of a bad block management method based on a super block group as shown in FIG. 9.

FIG. 12 is a diagram illustrating an example of super block management information of FIG. 7.

FIG. 13 is a diagram illustrating an example of bad block management information of FIG. 7.

FIG. 14 is a flowchart illustrating an example operation of a storage device based on some implementations of the disclosed technology.

FIG. 15 is a flowchart illustrating another example of an operation of a storage device based on some implementations of the disclosed technology.

FIG. 16 is a flowchart illustrating another example of an operation of a storage device based on some implementations of the disclosed technology.

FIG. 17 is a flowchart illustrating another example of an operation of a storage device based on some implementations of the disclosed technology.

FIG. 18 is a flowchart illustrating another example of an operation of a storage device based on some implementations of the disclosed technology.

FIG. 19 is a diagram for describing another example of a memory controller of FIG. 1 based on some implementations of the disclosed technology.

FIG. 20 is a block diagram illustrating an example of a memory card system to which a storage device is applied.

FIG. 21 is a block diagram illustrating an example of a solid state drive (SSD) system to which a storage device is applied.

FIG. 22 is a block diagram illustrating an example of a user system to which a storage device is applied.

### DETAILED DESCRIPTION

The technology disclosed in this patent document can be implemented to provide a storage device with improved capabilities including storage area management.

Hereinafter, the disclosed technology will be described in detail by describing various embodiments of the disclosed technology with reference to the accompanying drawings.

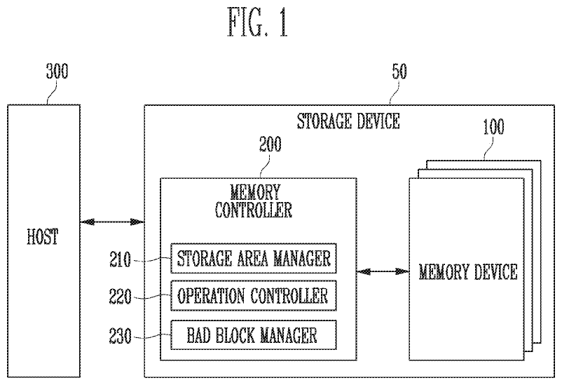

FIG. 1 is a diagram illustrating an example of a storage device based on some implementations of the disclosed technology.

Referring to FIG. 1, the storage device 50 may include a memory device 100 and a memory controller 200 controlling an operation of the memory device 100. The storage device 50 may be used to store and retrieve data according to requests from a host 300 such as a cellular phone, a smartphone, an MP3 player, a laptop computer, a desktop computer, a game player, a TV, a tablet PC, or an in-vehicle infotainment system.

The storage device 50 may be manufactured as one of various types of storage devices according to a host interface that is a communication interface between the host 300 and the storage device. For example, the storage device 50 may be configured as any one of various types of storage devices such as an SSD, a multimedia card in a form of an MMC, an eMMC, an RS-MMC and a micro-MMC, a secure digital card in a form of an SD, a mini-SD and a micro-SD, a universal serial bus (USB) storage device, a universal flash storage (UFS) device, a personal computer memory card international association (PCMCIA) card type storage device, a peripheral component interconnection (PCI) card type storage device, a PCI express (PCI-E) card type storage device, a compact flash (CF) card, a smart media card, and a memory stick.

The storage device 50 may be manufactured as any one of various types of packages. For example, the storage device 50 may be manufactured as any one of various types of package types, such as a package on package (POP), a system in package (SIP), a system on chip (SOC), a multi-chip package (MCP), a chip on board (COB), a wafer-level fabricated package (WFP), or a wafer-level stack package (WSP).

The memory device 100 may provide a storage space where data to be processed and/or instructions to be executed are stored. The memory device 100 may include the logic needed to read from and write to the memory device 100 and be operated in response to control of the memory controller 200. The memory device 100 may include a memory cell array including a plurality of memory cells which are configured to store data therein.

Each of the memory cells may be configured in various manners to store data. In some implementations, the memory cells can store a single bit or more bits of information In some implementations, the memory cells may be implemented as a single level cell (SLC) that stores one data bit, a multi-level cell (MLC) that stores two data bits, a triple level cell (TLC) that stores three data bits, or a quad level cell (QLC) that stores four data bits.

The memory cell array may include a plurality of memory blocks. Each of the memory blocks may include a plurality of pages, and each page corresponds to a plurality of memory cells. In an embodiment, read and program (write) operations are performed on a page basis, and erase operations are performed on a block basis.

The memory block may be a unit for erasing data. In an embodiment, the memory device 100 may be a double data rate synchronous dynamic random access memory (DDR SDRAM), a low power double data rate4 (LPDDR4) SDRAM, a graphics double data rate (GDDR) SDRAM, a low power DDR (LPDDR), a Rambus dynamic random access memory (RDRAM), a NAND flash memory, a vertical NAND flash memory, a NOR flash memory device, a resistive random access memory (RRAM), a phase-change memory (PRAM), a magnetoresistive random access memory (MRAM), a ferroelectric random access memory (FRAM), or a spin transfer torque random access memory (STT-RAM). In this patent document, for convenience of description, it is assumed that the memory device 100 is a NAND flash memory.

The memory controller 200 can access the memory device 100 based on requests from the user/host by providing command/address signals to the memory controller 200. In some implementations, the memory device 100 is configured to receive, from the memory controller 200, a command and an address in which the command is performed or executed, and may access the area of the memory cell array selected by the address. Thus, the memory device 100 may perform an operation in the area identified by the address based on the command requested by the user/host. For example, the memory device 100 may perform a write operation (program operation), a read operation, or an erase operation. During the program operation, data is written to the area (e.g., memory cell area) of the memory device 100, which is identified by the address. During the read operation, data is read from the area of the memory device 100, which is identified by the address. During the erase operation, data is erased from the area of the memory device, 100, which is identified by the address.

The memory controller 200 controls overall operations of the storage device 50.

When power is applied to the storage device 50, the memory controller 200 may execute firmware FW. When the memory device 100 is a flash memory device, the memory controller 200 may operate firmware such as a flash translation layer (FTL) for controlling communication between the host 300 and the memory device 100. In an implementation, a flash translation layer (FTL) may be situated in the memory controller 200 to implement logical-to-physical mapping, garbage collection, wear leveling management, and bad block management. For example, the FTL may provide an interface between a host interface layer and a flash interface layer.

In an embodiment, the memory controller 200 may receive data and a logical block address (LBA) from the host 300 and convert the logical block address (LBA) into a physical block address (PBA) indicating where the memory cells to write data to or read data form are.

The memory controller 200 may control the memory device 100 to perform the program operation, the read operation, or the erase operation based on a request from the host 300. During the program operation, the memory controller 200 may provide a program command, a physical block address, and data to the memory device 100. During the read operation, the memory controller 200 may provide a read command and the physical block address to the memory device 100. During the erase operation, the memory controller 200 may provide an erase command and the physical block address to the memory device 100.

In an embodiment, the memory controller 200 may generate and transmit the command, the address, and the data to the memory device 100 regardless of the request from the host 300. For example, the memory controller 200 may provide a command, an address, and data to the memory device 100 so as to perform background operations such as wear leveling or a “garbage collection.” The term “garbage collection” as used herein may refer to a form of memory management, in which a garbage collector attempts to reclaim (garbage) memory that is occupied by objects that are no longer in use. The wear leveling indicates techniques for prolonging lifetime of erasable storage devices.

In an embodiment, the memory controller 200 may control more than one memory device 100 at the same time. In this case, the memory controller 200 may control the memory devices 100 according to an interleaving method so as to improve operation performance. The interleaving method may improve system performance by performing more than one operation at a given time frame. For example, the interleaving method may perform operations on two or more memory devices 100 at the same time by interleaving a part of a queue associated with a memory device with a part of another queue associated with another memory device.

In an embodiment, the memory controller 200 may include a storage area manager 210, an operation controller 220, and a bad block manager 230.

The storage area manager 210 may provide a device identification command to the memory device 100, and obtain memory device stack information indicating the number of memory devices commonly connected to one channel.

For example, when two memory devices are connected to one channel, the memory device stack may be a double die package (DDP). When four memory devices are connected to one channel, the memory device stack may be a quad die package (QDP).

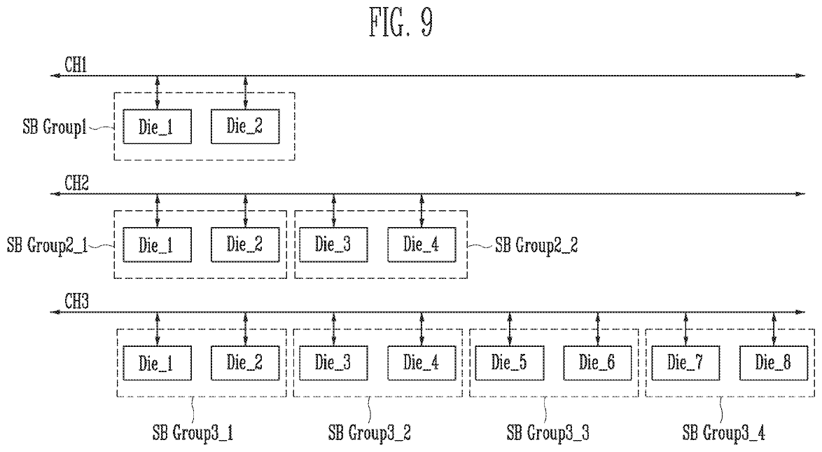

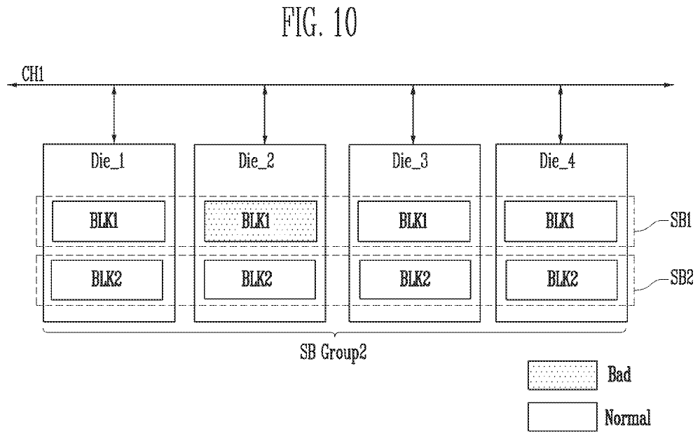

In an embodiment, the storage area manager 210 may allocate at least one memory device among the plurality of memory devices 100 to a plurality of super block groups having a default size, based on the memory device stack information. The super block group having the default size may include a preset number of memory devices. The storage area manager 210 may allocate the same number of memory devices to each super block group. The default size may be determined to appropriately manage a super block in consideration of a risk of reducing a user usable area at an occurrence of a bad block. The default size may be determined and set in advance at a manufacturing stage. The risk of reducing the user usable area will be described later with reference to FIGS. 10 and 11.

The storage area manager 210 may allocate at least two memory blocks to a super block, among the memory blocks included in the memory devices forming one super block group. The storage area manager 210 may perform its operation on a super block basis. Thus, the super block can be regarded as a new storage area unit managed by the storage area manager 210.

In an embodiment, at least two memory blocks may belong to different memory devices included in one super block group. In another embodiment, at least two memory blocks may belong to different planes among planes of one memory device included in one super block group.

The operation controller 220 may perform an operation based on a request from the host 300 on a basis of a super block unit. For example, data is stored in the super block or data is read from the super block. Thus, the operation controller 220 may control the memory devices 100 included in one super block group based on the request from the host 300.

In some implementations, the operation controller 220 may control the memory devices 100 included in one super block group using a stripe included in the super block. For example, data is stored in or read from a stripe selected among a plurality of stripes included in the super block.

The bad block manager 230 may generate bad block management information including state information indicating whether the super block is either a normal block or a bad block. When at least one of the memory blocks included in the super block is the bad block, the bad block manager 230 may update the state information of the super block from the normal block to the bad block.

The bad block indicates a block which cannot store data therein. There are two types of the bad block, i.e., a manufacturing bad block and a growing bad block, based on when the bad block is generated. The manufacturing bad block (MBB) is generated at the time of manufacturing the memory device 100 and the growing bad block (GBB) is generated during a use of the memory block. In an embodiment, if an uncorrectable error occurs in a memory block during a read operation for reading data stored in the memory block, the memory block may correspond to the growing bad block.

The host 300 may communicate with the storage device 50 using at least one of various communication methods such as a universal serial bus (USB), a serial AT attachment (SATA), a serial attached SCSI (SAS), a high speed interchip (HSIC), a small computer system interface (SCSI), a peripheral component interconnection (PCI), a PCI express (PCIe), a nonvolatile memory express (NVMe), a universal flash storage (UFS), a secure digital (SD), a multimedia card (MMC), an embedded MMC (eMMC), a dual in-line memory module (DIMM), a registered DIMM (RDIMM), and a load reduced DIMM (LRDIMM).

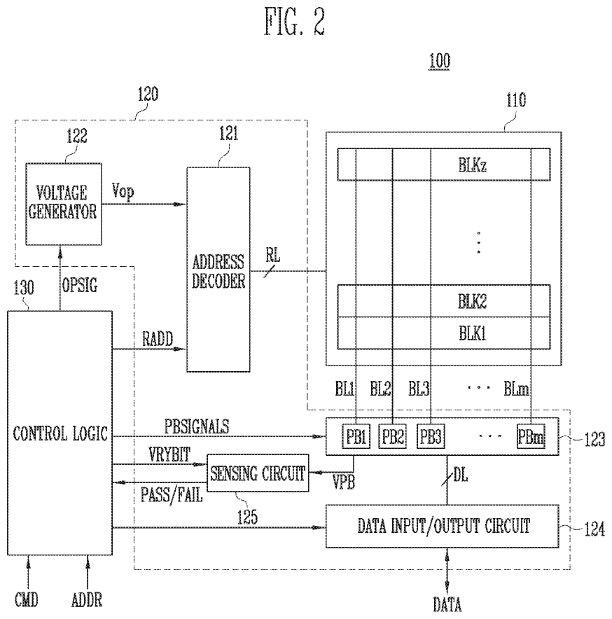

FIG. 2 is diagram illustrating an example configuration of a memory device of FIG. 1.

Referring to FIG. 2, a memory device 100 may include a memory cell array 110, a peripheral circuit 120, and a control logic 130.

The memory cell array 110 includes a plurality of memory blocks BLK1 to BLKz. The plurality of memory blocks BLK1 to BLKz are connected to an address decoder 121 through row lines RL. The plurality of memory blocks BLK1 to BLKz are connected to a read and write circuit 123 through bit lines BL1 to BLm. Each of the plurality of memory blocks BLK1 to BLKz includes a plurality of memory cells. As an embodiment, the plurality of memory cells are non-volatile memory cells. Memory cells connected to the same word line among the plurality of memory cells are defined as one physical page. That is, the memory cell array 110 is configured of a plurality of physical pages. According to an embodiment of the present disclosure, each of the plurality of memory blocks BLK1 to BLKz included in the memory cell array 110 may include a plurality of dummy cells. “dummy cells” may refer to memory cells that are used for purposes other than storing data. For example, at least one of the dummy cells may be connected in series between a drain select transistor and the memory cells and between a source select transistor and the memory cells to reduce unwanted interference between the drain/source select transistors and the memory cells.

Each of the memory cells of the memory device 100 may be configured as a single level cell (SLC) that stores one data bit, a multi-level cell (MLC) that stores two data bits, a triple level cell (TLC) that stores three data bits, or a quad level cell (QLC) that stores four data bits

The peripheral circuit 120 may include an address decoder 121, a voltage generator 122, the read and write circuit 123, a data input/output circuit 124, and a sensing circuit 125.

The peripheral circuit 120 may be used for I/O functions, power distribution, address decoding, etc. For example, the peripheral circuit 120 may drive word lines and bit lines to perform a program operation, a read operation, or an erase operation.

The address decoder 121 is connected to the memory cell array 110 through the row lines RL. The row lines RL may include drain select lines, word lines, source select lines, and a common source line. According to an embodiment of the present disclosure, the word lines may include normal word lines and dummy word lines. According to an embodiment of the present disclosure, the row lines RL may further include a pipe select line.

In an embodiment, the row lines RL may be local lines included in local line groups. The local line group may correspond to one memory block. The local line group may include the drain select line, local word lines, and the source select line.

The control logic 130 controls the operations of the peripheral circuit 120. The address decoder 121 receives an address (ADDR) from the control logic 130. The received address (ADDR) includes a block address and a row address that are decoded by the address decoder 121.

The address decoder 121 is configured to decode a block address of the received address (ADDR). The address decoder 121 selects at least one memory block among the memory blocks BLK1 to BLKz according to the decoded block address. The address decoder 121 is configured to decode a row address (RADD) of the received address (ADDR). The address decoder 121 may select at least one word line of a selected memory block based on the decoded row address (RADD). The at least one word line can be selected by applying voltages supplied from the voltage generator 122.

During the program operation, the address decoder 121 may apply a program voltage to a selected word line and apply a pass voltage having a level less than that of the program voltage to unselected word lines. During a program verify operation, the address decoder 121 may apply a verify voltage to the selected word line and apply a verify pass voltage having a level greater than that of the verify voltage to the unselected word lines.

During the read operation, the address decoder 121 may apply a read voltage to the selected word line and apply a read pass voltage having a level greater than that of the read voltage to the unselected word lines.

Based on some implementations of the disclosed technology, the erase operation of the memory device 100 is performed in the unit of a memory block. During the erase operation, the address (ADDR) including a block address is input to the memory device 100. The address decoder 121 may decode the block address and select one memory block based on the decoded block address. During the erase operation, the address decoder 121 may apply a ground voltage to the word lines coupled to the selected memory block.

Based on some implementations of the disclosed technology, the address decoder 121 may be configured to decode a column address of the address (ADDR). The decoded column address may be transferred to the read and write circuit 123. In an example, the address decoder 121 may include a component such as a row decoder, a column decoder, and an address buffer.

The voltage generator 122 is configured to generate a plurality of operation voltages (Vop) by using an external power voltage supplied to the memory device 100. The operations of the voltage generator 122 are controlled by the control logic 130.

In an example, the voltage generator 122 may generate an internal power voltage by regulating the external power voltage. The internal power voltage generated by the voltage generator 122 is used as an operation voltage of the memory device 100.

In an embodiment, the voltage generator 122 may generate the plurality of operation voltages (Vop) using the external power voltage or the internal power voltage. The voltage generator 122 may be configured to generate various voltages to operate the memory device 100. For example, the voltage generator 122 may generate a plurality of erase voltages, a plurality of program voltages, a plurality of pass voltages, a plurality of selection read voltages, and a plurality of non-selection read voltages.

The voltage generator 122 may include a plurality of pumping capacitors that receive the internal voltage and selectively activate the plurality of pumping capacitors to generate the plurality of operation voltages (Vop) Having various voltage levels.

The address decoder 121 may be configured to provide a plurality of operation voltages (Vop) to the memory cell array 110.

The read and write circuit 123 includes first to m-th page buffers PB1 to PBm. The first to m-th page buffers PB1 to PBm are connected to the memory cell array 110 through first to m-th bit lines BL1 to BLm, respectively. The first to m-th page buffers PB1 to PBm operate in response to the control of the control logic 130.

The first to m-th page buffers PB1 to PBm communicate data (DATA) with the data input/output circuit 124. For the program operation, the first to m-th page buffers PB1 to PBm receive the data (DATA) to be stored through the data input/output circuit 124 and data lines DL.

During the program operation, when a program pulse is applied to the selected word line, the first to m-th page buffers PB1 to PBm may transfer the data (DATA) that is to be stored in the memory cell array 110. For example, the data (DATA) received through the data input/output circuit 124 is transferred to the selected memory cells through the bit lines BL1 to BLm. The memory cells of the selected page are programmed based on the transferred data (DATA). A memory cell connected to a bit line to which a program permission voltage (for example, a ground voltage) is applied may have an increased threshold voltage. A threshold voltage of a memory cell connected to a bit line to which a program inhibition voltage (for example, a power voltage) is applied may be maintained. During the program verify operation, the first to m-th page buffers PB1 to PBm read the data (DATA) stored in the memory cells from the selected memory cells through the bit lines BL1 to BLm.

During the read operation, the read and write circuit 123 may read the data (DATA) from the memory cells of the selected page through the bit lines BL and store the read data (DATA) in the first to m-th page buffers PB1 to PBm.

During the erase operation, the read and write circuit 123 may float the bit lines BL. As an embodiment, the read and write circuit 123 may include a column selection circuit.

The data input/output circuit 124 is connected to the first to m-th page buffers PB1 to PBm through the data lines DL. The operations of the data input/output circuit 124 are controlled by the control logic 130.

The data input/output circuit 124 may include a plurality of input/output buffers (not shown) that receive input data (DATA). During the program operation, the data input/output circuit 124 receives the data (DATA) to be stored from an external controller (not shown). During the read operation, the data input/output circuit 124 outputs the data (DATA) transferred from the first to m-th page buffers PB1 to PBm included in the read and write circuit 123 to the external controller.

During the read operation or the verify operation, the sensing circuit 125 may generate a reference current in response to a signal of a permission bit (VRYBIT) generated by the control logic 130 and may compare a sensing voltage (VPB) received from the read and write circuit 123 with a reference voltage generated by the reference current to output a pass signal or a fail signal to the control logic 130.

The control logic 130 may be connected to the address decoder 121, the voltage generator 122, the read and write circuit 123, the data input/output circuit 124, and the sensing circuit 125. The control logic 130 may be configured to control the operations of the memory device 100. The control logic 130 may operate in response to a command (CMD) transferred from an external device.

The control logic 130 may generate various signals in response to the command (CMD) and the address (ADDR) to control the peripheral circuit 120. For example, the control logic 130 may generate an operation signal (OPSIG), the row address (RADD), a read and write circuit control signal (PBSIGNALS), and the permission bit (VRYBIT) based on the command (CMD and the address (ADDR). The control logic 130 may output the operation signal (OPSIG) to the voltage generator 122, output the row address (RADD) to the address decoder 121, output the read and write control signal to the read and write circuit 123, and output the permission bit (VRYBIT) to the sensing circuit 125. In some implementations, the control logic 130 may determine whether the verify operation is passed or failed in response to the pass or fail signal PASS/FAIL output by the sensing circuit 125.

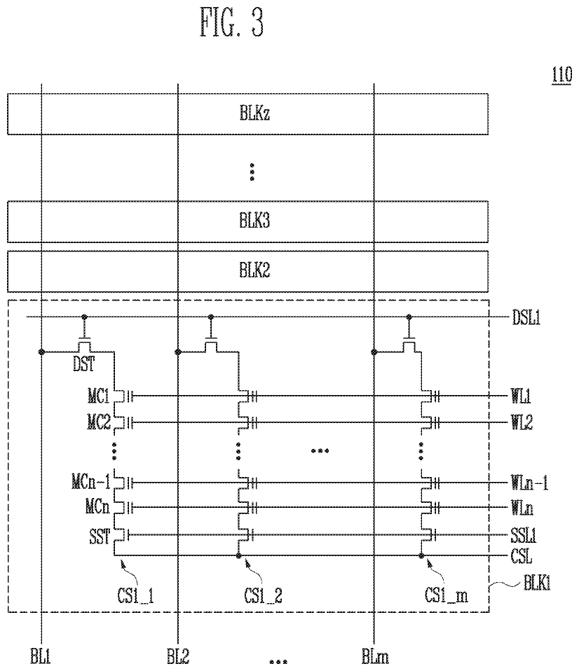

FIG. 3 is a diagram illustrating an example of the memory cell array of FIG. 2.

Referring to FIG. 3, the first to z-th memory blocks BLK1 to BLKz are connected to the first to m-th bit lines BL1 to BLm. In FIG. 3, for convenience of description, elements included in the first memory block BLK1 of the plurality of memory blocks BLK1 to BLKz are shown, and elements included in each of the remaining memory blocks BLK2 to BLKz are omitted. It will be understood that each of the remaining memory blocks BLK2 to BLKz is configured similarly to the first memory block BLK1.

The first memory block BLK1 may include a plurality of cell strings CS1_1 to CS1_m (m is a positive integer). The first to m-th cell strings CS1_1 to CS1_m are connected to the first to m-th bit lines BL1 to BLm, respectively. Each of the first to m-th cell strings CS1_1 to CS1_m includes a drain select transistor DST, a plurality of memory cells MC1 to MCn connected in series (n is a positive integer), and a source select transistor SST.

Gate terminals of the drain select transistors DST respectively included in each of the first to m-th cell strings CS1_1 to CS1_m are connected to a drain select line DSL1. Gate terminals of the first to n-th memory cells MC1 to MCn included in the first to m-th cell strings CS1_1 to CS1_m are connected to first to the n-th word lines WL1 to WLn, respectively. Gate terminals of the source select transistors SST included in the first to m-th cell strings CS1_1 to CS1_m are connected to a source select line SSL1.

For convenience of description, a structure of the cell string will be described with reference to the first cell string CS1_1 of the plurality of cell strings CS1_1 to CS1_m. However, it will be understood that each of the remaining cell strings CS1_2 to CS1_m is configured similarly to the first cell string CS1_1.

A drain terminal of the drain select transistor DST included in the first cell string CS1_1 is connected to the first bit line BL1. A source terminal of the drain select transistor DST included in the first cell string CS1_1 is connected to a drain terminal of the first memory cell MC1 included in the first cell string CS1_1. The first to n-th memory cells MC1 to MCn are connected in series with each other. A drain terminal of the source select transistor SST included in the first cell string CS1_1 is connected to a source terminal of the n-th memory cell MCn included in the first cell string CS1_1. A source terminal of the source select transistor SST included in the first cell string CS1_1 is connected to a common source line CSL. In an embodiment, the common source line CSL may be connected to the first to z-th memory blocks BLK1 to BLKz.

The drain select line DSL1, the first to n-th word lines WL1 to WLn, and the source select line SSL1 are included in row lines RL of FIG. 2. The drain select line DSL1, the first to n-th word lines WL1 to WLn, and the source select line SSL1 are controlled by the address decoder 121. The common source line CSL is controlled by the control logic 130. The first to m-th bit lines BL1 to BLm are controlled by the read and write circuit 123.

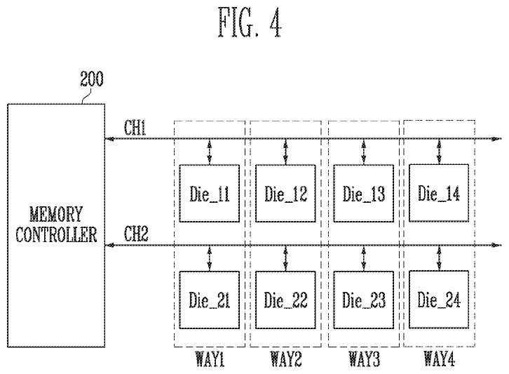

FIG. 4 is a diagram illustrating an example of a memory controller controlling a plurality of memory devices.

Referring to FIG. 4, the memory controller 200 may be connected to a plurality of memory devices Die_11 to Die_24 through a first channel CH1 and a second channel CH2. In an embodiment, the memory device may be an individual memory die or memory chip that has been physically processed on a wafer. The number of channels or the number of memory devices connected to each channel are not limited to the present embodiment.

The memory devices Die_11 to Die_14 may be commonly connected to the first channel CH1. The memory devices Die_11 to Die_14 may communicate with the memory controller 200 through the first channel CH1.

Since the memory devices Die_11 to Die_14 are commonly connected to the first channel CH1, one of the memory devices Die_11 to Die_14 may communicate with the memory controller 200 at a time. The memory devices Die_11 to Die_14 can simultaneously perform their operations without communicating with the memory controller 200.

The memory devices Die_21 to Die_24 may be commonly connected to the second channel CH2. The memory devices Die_21 to Die_24 may communicate with the memory controller 200 through the second channel CH2.

Since the memory devices Die_21 to Die_24 are commonly connected to the second channel CH2, one of the memory devices Die_21 to Die_24 may communicate with the memory controller 200 at a time. The memory devices Die_21 to Die_24 can simultaneously perform their operations without communicating with the memory controller 200.

A storage device using a plurality of memory devices may improve performance by using data interleaving. In order to achieve the data interleaving, the memory devices may be managed in units of channels and ways. The data interleaving may indicate data communication techniques using an interleaving scheme in a structure in which two or more ways share one channel. The data interleaving may include performing a read operation or a write operation while moving between two ways. In order to maximize parallelism of the memory devices connected to each channel, the memory controller 200 may disperse consecutive logical memory areas into the channel and the way and allocate the consecutive logical memory areas.

For example, the memory controller 200 may transmit a command, a control signal including an address, and data to the memory device Die_11 through the first channel CH1. The memory device Die_11 receives the data transmitted from the memory controller 200. While the memory device Die_11 programs the transmitted data to a memory cell included therein, the memory controller 200 may transmit a command, a control signal including an address, and data to the memory device Die_12.

In FIG. 4, the plurality of memory devices may be arranged to configure four ways WAY1 to WAY4. The first way WAY1 may include the memory devices Die_11 and Die_21. The second way WAY2 may include the memory devices Die_12 and Die_22. The third way WAY3 may include the memory devices Die_13 and Die_23. The fourth way WAY4 may include the memory devices Die_14 and Die_24.

Each of the channels CH1 and CH2 may be or correspond to a bus of signals shared and used by the memory devices connected to the corresponding channel.

In FIG. 4, the data interleaving in two channel/four way structure has been described. However, the data interleaving can be performed in other structures. The data interleaving can be more efficient as the number of channels and the number of ways increase.

FIG. 5 is a diagram illustrating an example of a super block according to an embodiment.

Referring to FIG. 5, memory devices Die_11 to Die_14 may be commonly connected to a first channel CH1.

In FIG. 5, each memory device may include one or more planes. For convenience of description, it is assumed in the example of FIG. 5 that one memory device includes one plane. One plane may include a plurality of memory blocks BLK1 to BLKn (n is a natural number of 1 or more), and one memory block may include a plurality of pages, Page 1 to Page k (k is a natural number of 1 or more).

A memory controller may control the memory devices coupled to one channel using a super block. In some implementations, the memory controller controls the memory devices in the unit of a super block. The super block may indicate a set of memory blocks included in at least two different memory devices.

For example, the first memory blocks BLK1 included in each of the memory devices Die_11 to Die_14 may configure a first super block 1 (Super Block 1). The second memory block BLK2 included in each of the memory devices Die_11 to Die_14 may configure a second super block (Super Block 2). The n-th memory blocks BLKn included in each of the memory devices Die_11 to Die_14 may configure an n-th super block (Super Block n). In this manner, the memory devices Die_11 to Die_14 connected to the first channel CH1 may include the first to n-th super blocks, Super Block 1 to Super Block n.

One super block may include one or more stripes. The stripe may include a set of pages included in the super block and coupled to a same word line. In some implementations, the stripe can be referred to as a super page.

One stripe or super page may include a plurality of pages. For example, the first pages (Page 1) of each of the plurality of first memory blocks, BLK1, included in the first super block (Super block 1) may configure a first stripe (Stripe 1) or a first super page (Super Page 1).

Therefore, one super block may include a first stripe, (Stripe 1) to k-th stripe (Stripe k). Alternatively, one super block may include first super page (Super Page 1) to k-th super page (Super Page k).

The memory controller may store or read data in the unit of a stripe or a super page in storing the data in the memory devices DIE_11 to DIE_14 or reading the stored data from the memory devices DIE_11 to DIE_14.

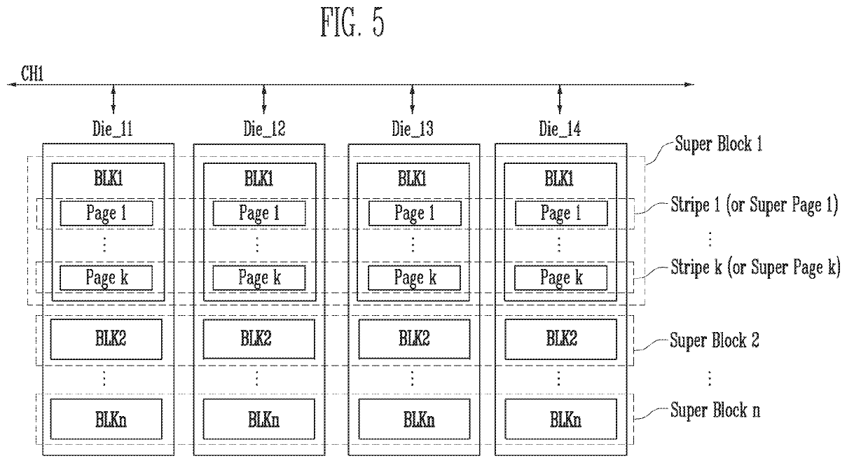

FIG. 6 is a diagram illustrating another example of a super block based on some implementations of the disclosed technology. The super block as shown in FIG. 6 is different from that of FIG. 5.

Referring to FIG. 6, a memory device may include one or more planes, Plane 1 to Plane 4. One plane may include a plurality of memory blocks BLK1 to BLKi (i is a positive integer). In an embodiment, the memory device may be any one of the plurality of memory devices of FIG. 4.

The number of planes included in one memory device is not limited to the example as shown in FIG. 6 and other implementations are also possible.

The plane may be a unit that independently performs a program operation, a read operation, or an erase operation. The memory device may include the address decoder 121 and the read and write circuit 123 described with reference to FIG. 2 for each plane.

In an embodiment, a super block may indicate a set of memory blocks included in at least two different planes.

For example, the first memory blocks BLK1 included in each of the plurality of planes 1 to 4 may configure a first super block SB1. The second memory blocks BLK2 included in each of the planes 1 to 4 may configure a second super block SB2. The i-th memory blocks BLKi included in each of the plurality of planes Plan 1 to Plan 4 may configure an i-th super block SBi. In this manner, the plurality of planes Plane 1 to Plane 4 included in one memory device may include the first to i-th super blocks SB1 to SBi.

As described with reference to FIG. 5, each super block may include one or more stripes or super pages. The memory controller may store or read data in the unit of a stripe or a super page in storing the data in the plurality of planes, Plane 1 to Plane 4, or reading the stored data from the plurality of planes, Plane 1 to Plane 4. Thus, the memory device may perform an operation (multi-plane operation) for the plurality of planes, Plane 1 to Plane 4, in parallel.

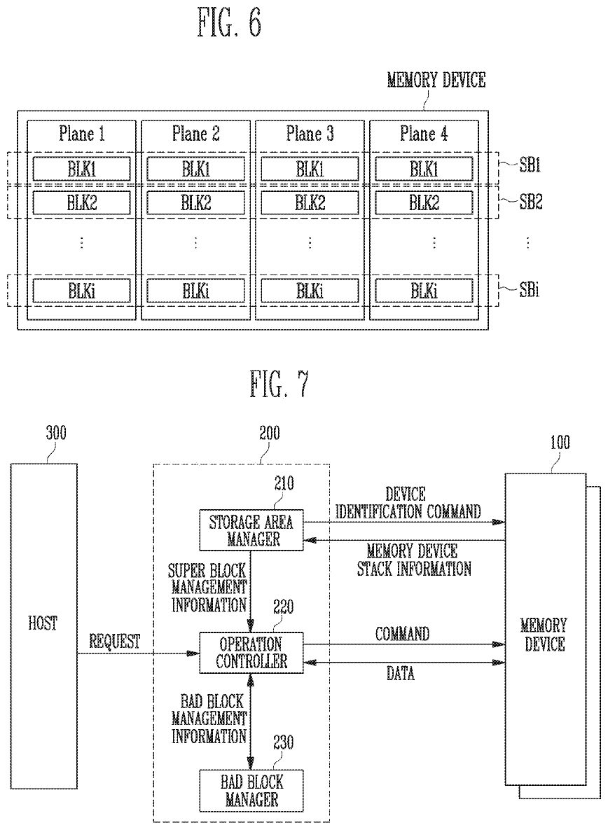

FIG. 7 is a diagram for describing a configuration and an operation of a memory controller based on some implementations of the disclosed technology.

Referring to FIG. 7, the memory controller 200 may include a storage area manager 210, an operation controller 220, and a bad block manager 230.

The storage area manager 210 may provide a device identification command to a memory device 100, and obtain memory device stack information indicating the number of memory devices commonly connected to one channel from the memory device 100.

In an embodiment, the storage area manager 210 may receive the memory device stack information from the memory device and allocate, based on the memory device stack information, at least one memory device among the plurality of memory devices 100 to one or more super block groups having a default size.

In an embodiment, the super block group having the default size may include a preset number of memory devices. Alternatively, the super block group having the default size may include a preset number of planes. In some implementations, the planes may be included in the same memory device or different memory devices. The storage area manager 210 may allocate the same number of memory devices to each super block group.

The storage area manager 210 may allocate at least two memory blocks included in the memory devices allocated to one super block group as the super block. The storage area manager 210 may manage or use the super block as a unit for a new storage area.

In an embodiment, at least two memory blocks may belong to different memory devices included in one super block group. In another embodiment, at least two memory blocks may belong to different planes of one memory device included in one super block group.

The storage area manager 210 may generate and provide super block management information to the operation controller 220. The super block management information may indicate super blocks included in each of the super block groups allocated by the storage area manager 210.

The operation controller 220 may perform an operation based on a request of a host 300 using a super block based on the super block management information. Thus, the super block is used as a unit for performing the operation requested from the host 300.

For example, the operation controller 220 may provide program commands for storing data in the super block to the memory devices 100 included in one super block group based on the request of the host 300. The operation controller 220 may provide read commands for reading data stored in the super block to the memory devices 100 included in one super block group based on the request of the host 300.

In some implementations, the operation controller 220 may provide program commands for storing data in a stripe selected among the plurality of stripes included in the super block described with reference to FIG. 5 to the memory devices 100 included in one super block group. The operation controller 220 may provide read commands for reading data stored in the selected stripe to the memory devices 100.

The operation controller 220 may exclude the super block, which is a bad block, when controlling the operation for the super block based on the request of the host 300. To exclude the super block which is the bad block, the operation controller 220 receive bad block management information provided from the bad block manager 230.

The bad block manager 230 may generate the bad block management information including state information indicating whether the super block is either a normal block or a bad block. The bad block management information may include state information of each of the super blocks included in each super block group.

The state information of a super block may be initially set to the normal block. When at least one bad block occurs among the memory blocks included in the super block, the bad block manager 230 may update the state information of the super block from the normal block to the bad block.

The bad block indicates a block in which data cannot be stored. The bad block may be divided based on a time point when the bad block is generated into a manufacturer bad block (MBB) generated at the time of manufacturing the memory device 100 and a growth bad block (GBB) generated during a use of the memory block. In an embodiment, if an uncorrectable error occurs to a memory block when reading data stored in the memory block, the memory block may become the growth bad block.

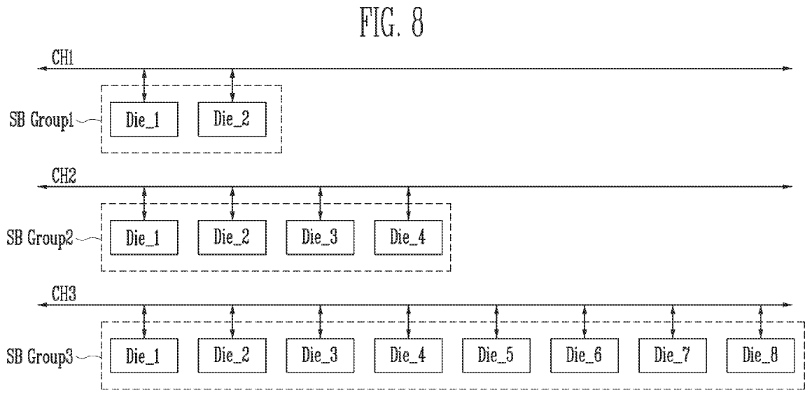

FIG. 8 is a diagram for illustrating an example method of allocating a super block based on some implementations of the disclosed technology.

Referring to FIG. 8, since the number of memory devices commonly connected to a first channel CH1 is two, a memory device stack may be a double die package (DDP). Since the number of memory devices commonly connected to a second channel CH2 is four, the memory device stack may be a quad die package (QDP). Since the number of memory devices commonly connected to a third channel CH3 is eight, the memory device stack may be an octa die package (ODP). The channels CH1 to CH3 can be connected to separate memory controllers.

When the memory device stack is the DDP, memory devices Die_1 and Die_2 may configure a super block group (SB Group1). When the memory device stack is the QDP, memory devices Die_1 to Die_4 may configure a super block group (SB Group2). When the memory device stack is the ODP, memory devices Die_1 to Die_8 may configure a super block group (SB Group3).

In the case of FIG. 8, the memory devices connected to each of the channels can configure one super block group, while each of the super block group has different numbers of memory devices (memory device stack) connected to the respective channels.

With reference to FIG. 5, the number of memory blocks included in a super block can increase as the number of memory devices allocated to one super block group increases. Thus, a size of the super block can increase as well.

FIG. 9 is a diagram for illustrating an example method of allocating a super block based on some implementations of the disclosed technology.

Referring to FIG. 9, in comparison with FIG. 8, memory devices connected to one channel may be allocated to super block groups having a default size. The super block group of the default size may include a preset number of memory devices. Alternatively, the super block group of the default size may include a preset number of planes with reference to FIG. 6. In an embodiment, a memory device may be an individual memory die or memory chip for which physical processes have been completed on a wafer.

In FIG. 9, it is assumed that the default size of the super block group corresponds to two memory devices. Thus, the super block group with the default size includes two memory devices. The number of memory devices or the number of planes included in the super block group having the default size is not limited to the present embodiment.

For example, when a stack of the memory device is a DDP, the super block groups (SB Group 1) has the default size and the number of super block groups having the default size is one. When the stack of the memory device is a QDP, the super block groups (SB Group 2_1 and SB Group 2_2) have the default size and the number of super block groups having the default size is two. When the stack of the memory device is an ODP, the super block groups (SB Group3_1 to SB Group3_4) have the default size and the number of super block groups having the default size is four.

In the example of FIG. 9, differently from FIG. 8, the number of super block groups having the default size may depend on the number of memory devices connected to one channel.

The number of memory devices allocated to one super block group is fixed, and thus the super block has a fixed size. Therefore, even when the number of memory devices connected to one channel increases, the number of memory devices allocated to each super block group is the same.

FIG. 10 is a diagram for illustrating an example of a bad block management method based on a super block group as shown in FIG. 8.

Referring to FIG. 10, memory devices Die_1 to Die_4 may be allocated to the second super block group (SB Group2) of FIG. 8. It is assumed that each of the memory devices Die_1 to Die_4 includes first and second memory blocks BLK1 and BLK2. The number of memory blocks included in the memory device is not limited to the present embodiment.

In the example of FIG. 10, the memory devices Die_1 to Die_4 may configure super blocks SB1 and SB2. Each super block may include memory blocks included in different memory devices Die_1 to Die_4.

For example, the super block SB1 may include first memory blocks BLK1 included in each of the memory devices Die_1 to Die_4. The super block SB2 may include second memory blocks BLK2 included in each of the memory devices Die_1 to Die_4.

Therefore, the super block group (SB Group2) may include the two super blocks SB1 and SB2 each including four memory blocks.

It is assumed that among the memory blocks included in the super block SB1, the first memory block BLK1 of the memory device Die_2 is a bad block. In this case, the super block SB1 may be processed as a bad block. When the first super block SB1 is processed as the bad block, the use of all normal blocks included in the super block SB1 may be prohibited. For the super block SB1, the use of the remaining three normal blocks is prohibited due to one bad block of four memory blocks included in the super block SB1, which results in the waste of storage capacity.

FIG. 11 is a diagram for illustrating an example of a bad block management method based on a super block group as shown in FIG. 9.

Referring to FIG. 11, memory devices Die_1 and Die2 may be allocated to a super block group (SB Group2_1). Memory devices Die_3 and Die4 may be allocated to a super block group (SB Group2_2). It is assumed that each of the memory devices Die_1 to Die_4 includes first and second memory blocks BLK1 and BLK2. The number of memory blocks included in the memory device is not limited to the present embodiment.

In the example of FIG. 11, the memory devices Die_1 and Die_2 may configure super blocks SB1′ and SB2′. The memory devices Die_3 and Die_4 may configure super blocks SB3′ and SB4′.

For example, the super block SB1′ may include the first memory block BLK1 included in each of the memory devices Die_1 and Die_2. The super block SB2′ may include the second memory block BLK2 included in each of the memory devices Die_1 and Die_2. The super block SB3′ may include the first memory block BLK1 included in each of the memory devices Die_3 and Die_4. The super block SB4′ may include the second memory block BLK2 included in each of the memory devices Die_3 and Die_4.

In the example of FIG. 11, the super block groups (SB Group2_1 and SB Group2_2) having a default size may include two super blocks each including two memory blocks.

It is assumed that the first memory block BLK1 of the memory device Die_2 is a bad block. In this case, the super block SB1′ may be processed as a bad block. When the first super block SB1′ is processed as the bad block, the use of all normal blocks included in the super block SB1′ may be prohibited. For the super block SB1′, the use of the remaining one normal block may be prohibited due to one bad block of two memory blocks included in the super block SB1′. As compared to the case of FIG. 10, in a case of FIG. 11, waste of storage capacity can be reduced and this reduction is based on the difference in the super block allocation method.

In the example of FIG. 10, as the number of memory devices connected to one channel increases, a size of one super block increases, and thus risk of not using the remaining normal blocks also increases when at least one bad block is generated in the super block.

In the example of FIG. 11, the number of super block groups having a default size depends on the number of memory devices connected to one channel, and thus one super block has a fixed size. In this case, when at least one bad block is generated in the super block, the risk of not using the remaining normal blocks can be reduced in comparison with FIG. 10. Thus, even when the super block is processed as the bad block, the number of normal blocks that are not used can be reduced in comparison with FIG. 10.

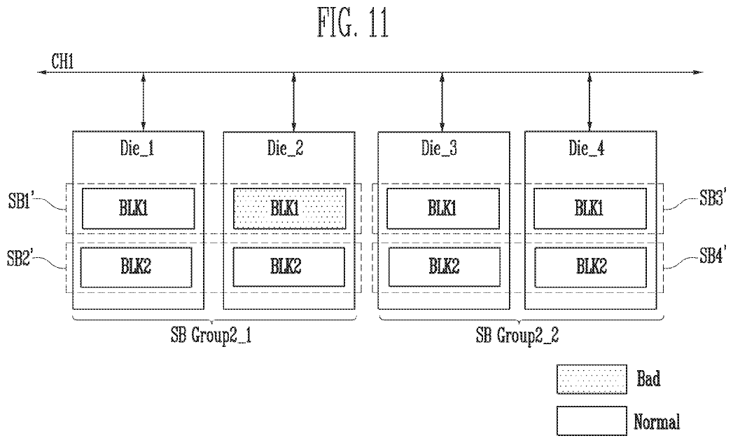

FIG. 12 is a diagram illustrating an example of super block management information of FIG. 7.

Referring to FIG. 12, the super block management information may indicate super blocks included in each super block group.

In the example of FIG. 12, the super block group (SB Group2_1) includes the super blocks SB1′ and SB2′. The super block group (SB Group2_2) includes super blocks SB3′ and SB4′.

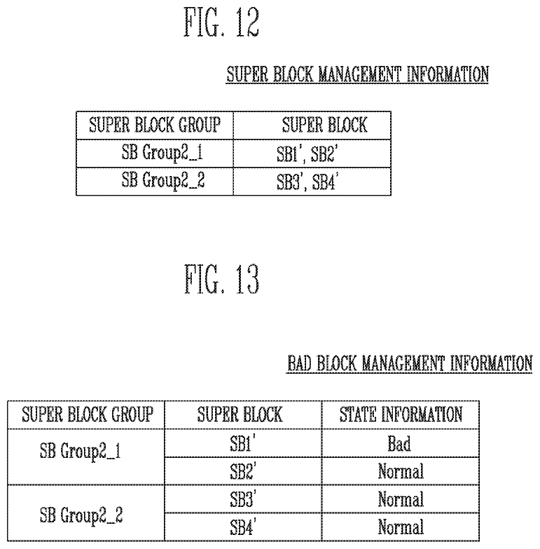

FIG. 13 is a diagram illustrating an example of bad block management information of FIG. 7.

Referring to FIG. 13, the bad block management information may include state information indicating whether a super block is either a normal block or a bad block.

The bad block management information may include state information on each of super blocks included in each super block group. As previously discussed, the state information of the super block may be initially set to the normal block. The state information included in the bad block management information indicates the current state information of the super block.

For example, the table as shown in FIG. 13 indicates that a super block SB1′ included in a super block group (SB Group2_1) is the bad block, a super block SB2′ included in the super block group (SB Group2_1) is the normal block, a super block SB3′ included in a super block group (SB Group2_2) is the normal block, and a super block SB4′ included in the super block group (SB Group2_2) is the normal block.

The bad block management information can provide information, for the unit of a super block, whether the super block is either the bad block or the normal block. For example, when at least one bad block is generated in the super block, the state information of the super block is updated from the normal block to the bad block. In this case, the use of the remaining normal blocks included in the super block may be prohibited.

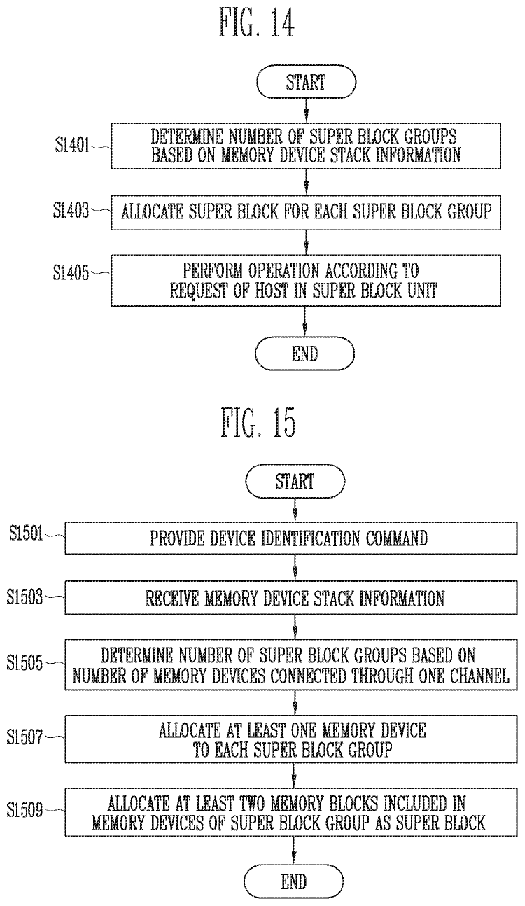

FIG. 14 is a flowchart illustrating an operation of a storage device based on some implementations of the disclosed technology.

Referring to FIG. 14, in step S1401, a storage device may determine the number of super block groups having a default size based on memory device stack information.

In step S1403, the storage device may allocate, to each super block group, a super block that includes at least two memory blocks among memory blocks included in memory devices of the super block group.

In step S1405, the storage device may perform an operation based on a request of a host in the unit of a super block. The storage device may control the memory devices of the super block group including the super block to perform an operation based on the request of the host.

FIG. 15 is a flowchart illustrating another example of an operation of a storage device based on some implementations of the disclosed technology.

Referring to FIG. 15, in step S1501, a memory controller included in the storage device may provide a device identification command to memory devices included in the storage device.

In step S1503, the memory controller included in the storage device may receive memory device stack information from the memory device. The memory device stack information may include information on the number of memory devices commonly connected to one channel.

In step S1505, the storage device may determine the number of super block groups having a default size based on the number of memory devices commonly connected to one channel. In an embodiment, the memory device may be an individual memory die or memory chip for which physical processes have been completed on a wafer.

In step S1507, the storage device may allocate, to each super block group, at least one memory device among the memory devices connected to one channel.

In step S1509, the storage device may allocate, to a super block, at least two memory blocks included in the memory devices of the super block group.

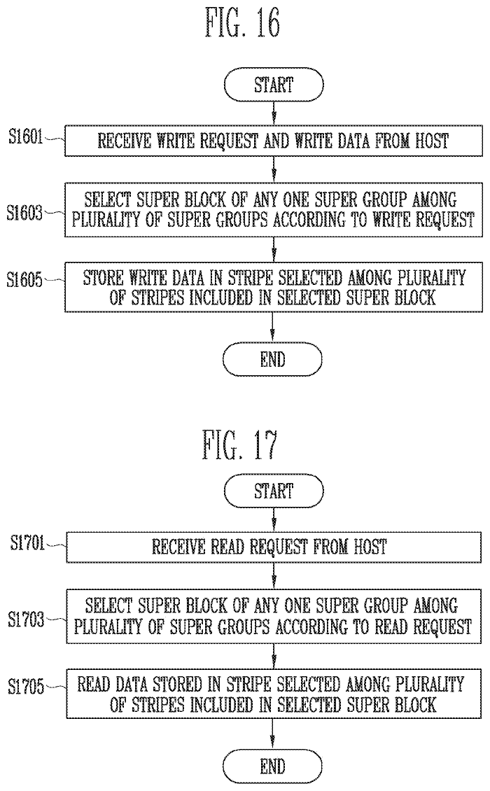

FIG. 16 is a flowchart illustrating another example of an operation of a storage device based on some implementations of the disclosed technology.

Referring to FIG. 16, in step S1601, the storage device may receive a write request and write data from a host.

In step S1603, the storage device may select a super block included in any super block group among a plurality of super block groups based on the write request.

In step S1605, the storage device may store the write data in a stripe selected among a plurality of stripes included in a selected super block.

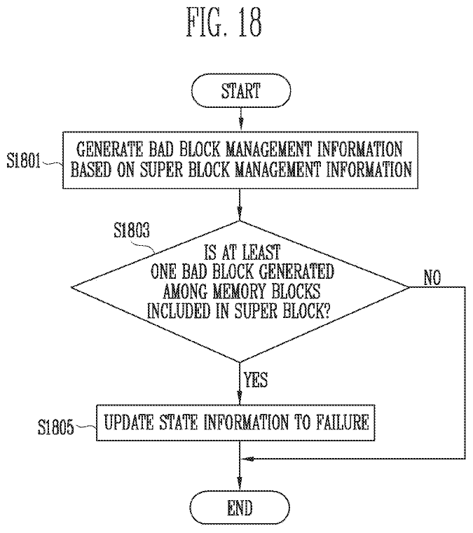

FIG. 17 is a flowchart illustrating another example of an operation of a storage device based on some implementations of the disclosed technology.

Referring to FIG. 17, in step S1701, the storage device may receive a read request from a host.

In step S1703, the storage device may select a super block included in any super block group among a plurality of super block groups based on the read request.

In step S1705, the storage device may read data stored in the selected stripe among the plurality of stripes included in the selected super block.

FIG. 18 is a flowchart illustrating another example of an operation of a storage device based on some implementations of the disclosed technology.

Referring to FIG. 18, in step S1801, the storage device may generate bad block management information based on super block management information. The bad block management information may include state information of each of super blocks included in a super block group. The state information of the super block may be initially set to a normal block.

In step S1803, the storage device may determine whether at least one bad block generates among the memory blocks included in the super block. When at least one bad block is generated among the memory blocks included in the super block, the operation proceeds to step S1805, and when all memory blocks included in the super block are normal blocks, the operation is ended.

In step S1805, the storage device may update the state information of the super block from the normal block to the bad block indicating failure.

FIG. 19 is a diagram illustrating another example of an operation of a memory controller of FIG. 1 based on some implementations of the disclosed technology.

Referring to FIG. 19, the memory controller 1000 is connected to the host (Host) and the memory device. The memory controller 1000 is configured to access the memory device in response to the request from the host (Host). For example, the memory controller 1000 is configured to control write, read, erase, and background operations of the memory device. The memory controller 1000 is configured to provide an interface between the memory device and the host (Host). The memory controller 1000 is configured to drive firmware for controlling the memory device.

The memory controller 1000 may include a processor 1010, a memory buffer 1020, an error corrector (ECC) 1030, a host interface 1040, a buffer control circuit 1050, a memory interface 1060, and a bus 1070.

The bus 1070 may be configured to provide a channel between components of the memory controller 1000.

The processor 1010 may control overall operations of the memory controller 1000 and may perform a logical operation. The processor 1010 may communicate with an external host through the host interface 1040 and communicate with the memory device through the memory interface 1060. In addition, the processor 1010 may communicate with the memory buffer 1020 through the buffer controller 1050. The processor 1010 may control an operation of the storage device using the memory buffer 1020 as an operation memory, a cache memory, or a buffer memory.

The processor 1010 may perform a function of a flash translation layer (FTL). The processor 1010 may convert a logical block address (LBA) provided by the host into a physical block address (PBA) through the flash translation layer (FTL). The flash translation layer (FTL) may receive the logical block address (LBA) using a mapping table and may convert the logical block address (LBA) into the physical block address (PBA). There are various address mapping methods of the flash translation layer, based on a mapping unit. Representative address mapping methods include a page mapping method, a block mapping method, or a hybrid mapping method.

The processor 1010 is configured to randomize data received from the host (Host). For example, the processor 1010 may randomize the data received from the host (Host) using a randomizing seed. The randomized data is provided to the memory device as data to be stored and is programmed to the memory cell array.

The processor 1010 is configured to de-randomize data received from the memory device during the read operation. For example, the processor 1010 may de-randomize the data received from the memory device using a de-randomizing seed. The de-randomized data may be output to the host (Host).

In an embodiment, the processor 1010 may perform the randomization and the de-randomization by driving software or firmware.

The memory buffer 1020 may be used as an operation memory, a cache memory, or a buffer memory of the processor 1010. The memory buffer 1020 may store codes and commands executed by the processor 1010. The memory buffer 1020 may store data processed by the processor 1010. The memory buffer 1020 may include a static RAM (SRAM) or a dynamic RAM (DRAM).

The error corrector 1030 may perform error correction. The error corrector 1030 may perform error correction encoding (ECC encoding) based on data to be written to the memory device through memory interface 1060. The error correction encoded data may be transferred to the memory device through the memory interface 1060. The error corrector 1030 may perform error correction decoding (ECC decoding) on the data received from the memory device through the memory interface 1060. In an example, the error corrector 1030 may be included in the memory interface 1060 as a component of the memory interface 1060.

The host interface 1040 is configured to communicate with an external host under control of the processor 1010. The host interface 1040 may be configured to perform communication using at least one of various communication methods such as a universal serial bus (USB), a serial AT attachment (SATA), a serial attached SCSI (SAS), a high speed interchip (HSIC), a small computer system interface (SCSI), a peripheral component interconnection (PCI express), a nonvolatile memory express (NVMe), a universal flash storage (UFS), a secure digital (SD), a multimedia card (MMC), an embedded MMC (eMMC), a dual in-line memory module (DIMM), a registered DIMM (RDIMM), and a load reduced DIMM (LRDIMM).

The buffer controller 1050 is configured to control the memory buffer 1020 under the control of the processor 1010.

The memory interface 1060 is configured to communicate with the memory device under the control of the processor 1010. The memory interface 1060 may communicate a command, an address, and data with the memory device through a channel.

In an example, the memory controller 1000 may not include the memory buffer 1020 and the buffer controller 1050.

In an example, the processor 1010 may control the operation of the memory controller 1000 using codes. The processor 1010 may load the codes from a non-volatile memory device (for example, a read only memory) provided inside the memory controller 1000. In another example, the processor 1010 may load the codes from the memory device through the memory interface 1060.

In an example, the bus 1070 of the memory controller 1000 may be divided into a control bus and a data bus. The data bus may be configured to transmit data within the memory controller 1000 and the control bus may be configured to transmit control information such as a command and an address within the memory controller 1000. The data bus and the control bus may be separated from each other and may not interfere with each other or affect each other. The data bus may be connected to the host interface 1040, the buffer controller 1050, the error corrector 1030, and the memory interface 1060. The control bus may be connected to the host interface 1040, the processor 1010, the buffer controller 1050, the memory buffer 1202, and the memory interface 1060.

In an embodiment, the processor 1010 may include a storage area manager 1011 and a bad block manager 1012. The storage area manager 1011 may manage a storage area of the memory device in the same manner as the storage area manager 210 of FIG. 7. The bad block manager 1012 may perform bad block management of a super block in the same manner as the bad block manager 230 of FIG. 7.

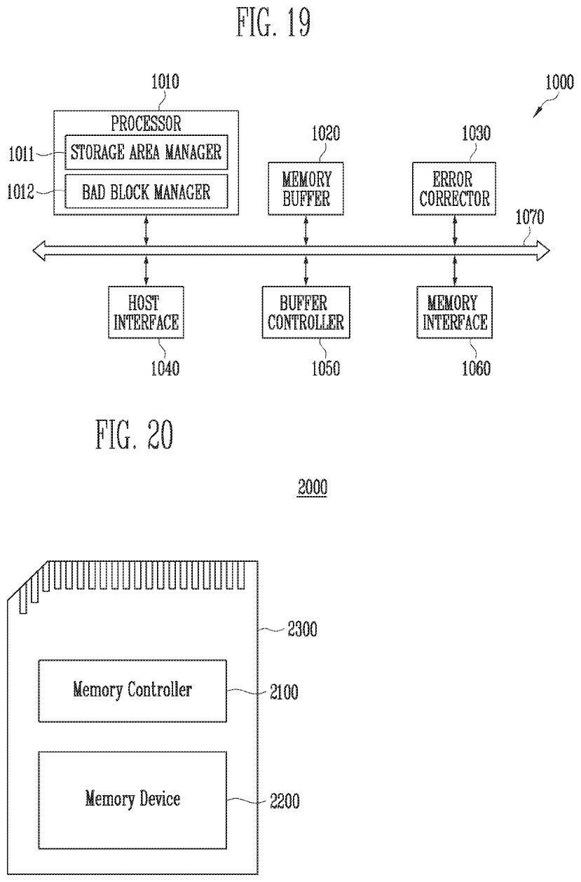

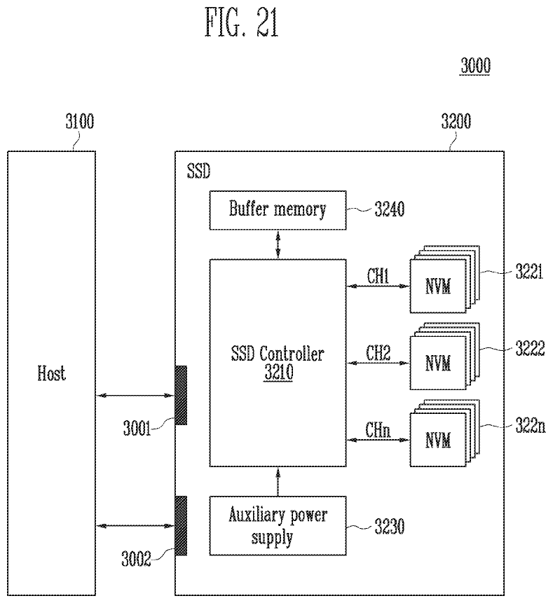

FIG. 20 is a block diagram illustrating a memory card system to which a storage device is applied based on some implementations of the disclosed technology.

Referring to FIG. 20, the memory card system 2000 includes a memory controller 2100, a memory device 2200, and a connector 2300.

The memory controller 2100 is connected to the memory device 2200. The memory controller 2100 is configured to access the memory device 2200. For example, the memory controller 2100 may be configured to control read, write, erase, and background operations of the memory device 2200. The memory controller 2100 is configured to provide an interface between the memory device 2200 and the host (Host). The memory controller 2100 is configured to drive firmware for controlling the memory device 2200. The memory controller 2100 may be implemented equally to the memory controller 200 described with reference to FIG. 1.

In an example, the memory controller 2100 may include components such as a random access memory (RAM), a processor, a host interface, a memory interface, or an error corrector.

The memory controller 2100 may communicate with an external device through the connector 2300. The memory controller 2100 may communicate with an external device (for example, the host) according to a specific communication standard. In an example, the memory controller 2100 is configured to communicate with an external device through at least one of various communication standards such as a universal serial bus (USB), a multimedia card (MMC), an embedded MMC (MCM), a peripheral component interconnection (PCI), a PCI express (PCI-E), an advanced technology attachment (ATA), a serial-ATA, a parallel-ATA, a small computer system interface (SCSI), an enhanced small disk interface (ESDI), integrated drive electronics (IDE), FireWire, a universal flash storage (UFS), Wi-Fi, Bluetooth, or an NVMe. In an example, the connector 2300 may be configured to operate based on at least one of the various communication standards described above.

In an example, the memory device 2200 may be configured as various non-volatile memory elements such as an electrically erasable and programmable ROM (EEPROM), a NAND flash memory, a NOR flash memory, a phase-change RAM (PRAM), a resistive RAM (ReRAM), a ferroelectric RAM (FRAM), or a spin-torque magnetic RAM (STT-MRAM).

The memory controller 2100 and the memory device 2200 may be integrated into one semiconductor device to configure a memory card. For example, the memory controller 2100 and the memory device 2200 may be integrated into one semiconductor device to configure a memory card such as a PC card (personal computer memory card international association (PCMCIA)), a compact flash card (CF), a smart media card (SM or SMC), a memory stick, a multimedia card (MMC, RS-MMC, MMCmicro, or eMMC), an SD card (SD, miniSD, microSD, or SDHC), or a universal flash storage (UFS).

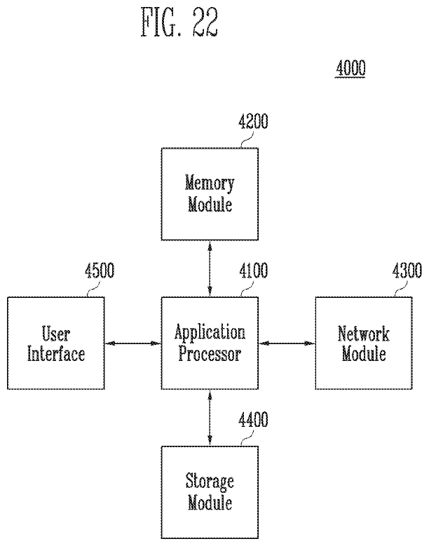

FIG. 21 is a block diagram illustrating a solid state drive (SSD) system to which a storage device is applied based on some implementations of the disclosed technology.

Referring to FIG. 21, the SSD system 3000 includes a host 3100 and an SSD 3200. The SSD 3200 exchanges a signal SIG with the host 3100 through a signal connector 3001 and receives power PWR through a power connector 3002. The SSD 3200 includes an SSD controller 3210, a plurality of flash memories 3221 to 322n, an auxiliary power device 3230, and a buffer memory 3240.

Based on some implementations of the disclosed technology, the SSD controller 3210 may perform the function of the memory controller 200 described with reference to FIG. 1.

The SSD controller 3210 may control the plurality of flash memories 3221 to 322n in response to the signal SIG received from the host 3100. In an example, the signal SIG may be signals based on an interface between the host 3100 and the SSD 3200. For example, the signal SIG may be a signal defined by at least one of interfaces such as a universal serial bus (USB), a multimedia card (MMC), an embedded MMC (MCM), a peripheral component interconnection (PCI), a PCI express (PCI-E), an advanced technology attachment (ATA), a serial-ATA, a parallel-ATA, a small computer system interface (SCSI), an enhanced small disk interface (ESDI), integrated drive electronics (IDE), FireWire, a universal flash storage (UFS), Wi-Fi, Bluetooth, or an NVMe.

The auxiliary power device 3230 is connected to the host 3100 through the power connector 3002. The auxiliary power device 3230 may receive the power PWR from the host 3100 and may charge the power. The auxiliary power device 3230 may provide power of the SSD 3200 when power supply from the host 3100 is not smooth. In an example, the auxiliary power device 3230 may be positioned in the SSD 3200 or may be positioned outside the SSD 3200. For example, the auxiliary power device 3230 may be positioned on a main board and may provide auxiliary power to the SSD 3200.

The buffer memory 3240 operates as a buffer memory of the SSD 3200. For example, the buffer memory 3240 may temporarily store data received from the host 3100 or data received from the plurality of flash memories 3221 to 322n, or may temporarily store metadata (for example, a mapping table) of the flash memories 3221 to 322n. The buffer memory 3240 may include a volatile memory such as a DRAM, an SDRAM, a DDR SDRAM, an LPDDR SDRAM, and a GRAM, or a non-volatile memory such as an FRAM, a ReRAM, an STT-MRAM, or a PRAM.

FIG. 22 is a block diagram illustrating an example of a user system to which a storage device is applied based on some implementations of the disclosed technology.

Referring to FIG. 22, the user system 4000 includes an application processor 4100, a memory module 4200, a network module 4300, a storage module 4400, and a user interface 4500.

The application processor 4100 may drive components, an operating system (OS), a user program, or the like included in the user system 4000. In an example, the application processor 4100 may include controllers, interfaces, graphics engines, and the like that control the components included in the user system 4000. The application processor 4100 may be provided as a system-on-chip (SoC).

The memory module 4200 may operate as a main memory, an operation memory, a buffer memory, or a cache memory of the user system 4000. In some implementations, the memory module 4200 may include a volatile random access memory such as a DRAM, an SDRAM, a DDR SDRAM, a DDR2 SDRAM, a DDR3 SDRAM, an LPDDR SDARM, an LPDDR2 SDRAM, or an LPDDR3 SDRAM. In some implementations, the memory module 4200 may include a non-volatile random access memory, such as a PRAM, a ReRAM, an MRAM, or an FRAM. In an example, the application processor 4100 and memory module 4200 can be packaged based on a package on package (POP) and provided as one semiconductor package.

The network module 4300 may communicate with external devices. In an example, the network module 4300 may support wireless communication such as code division multiple access (CDMA), global system for mobile communications (GSM), wideband CDMA (WCDMA), CDMA-2000, time division multiple access (TDMA), long term evolution, Wimax, WLAN, UWB, Bluetooth, or Wi-Fi. In an example, the network module 4300 may be included in the application processor 4100.

The storage module 4400 may store data. For example, the storage module 4400 may store data received from the application processor 4100. Alternatively, the storage module 4400 may transmit data stored in the storage module 4400 to the application processor 4100. In an example, the storage module 4400 may be implemented as a non-volatile semiconductor memory element such as a phase-change RAM (PRAM), a magnetic RAM (MRAM), a resistive RAM (RRAM), a NAND flash, a NOR flash, or a three-dimensional NAND flash. In an example, the storage module 4400 may be provided as a removable storage device (removable drive), such as a memory card, and an external drive of the user system 4000.

In an example, the storage module 4400 may include a plurality of non-volatile memory devices, and the plurality of non-volatile memory devices may operate equally to the memory device 100 described with reference to FIG. 1. The storage module 4400 may operate similarly to the storage device 50 described with reference to FIG. 1.

The user interface 4500 may include interfaces for inputting data or an instruction to the application processor 4100 or for outputting data to an external device. In an example, the user interface 4500 may include user input interfaces such as a keyboard, a keypad, a button, a touch panel, a touch screen, a touch pad, a touch ball, a camera, a microphone, a gyroscope sensor, a vibration sensor, or a piezoelectric element. The user interface 4500 may include user output interfaces such as a liquid crystal display (LCD), an organic light emitting diode (OLED) display device, an active matrix OLED (AMOLED) display device, an LED, a speaker, or a motor.

Although the disclosed technology has been described with reference to the embodiments and drawings that are discussed in this patent document, the disclosed technology is not limited to the embodiments described above, and various changes and modifications can be made.

In the embodiments described above, at least some of the steps may optionally be performed or omitted. In addition, the steps in each embodiment need not occur in order, and the order can be changed.

What is claimed is:

1. A memory controller for controlling one or more memory devices, comprising:
a storage area manager configured to:
determine a number of super block groups having a predetermined size based on a number of memory devices connected to the memory controller through a channel,
allocate at least one memory device to each of the super block groups, and
allocate at least two memory blocks included in the at least one memory device in each of the super block groups as a super block; and
an operation controller in communication with the storage area manager and configured to control the at least one memory device in each of the super block groups to store data in the super block or to read data stored in the super block.

2. The memory controller of claim 1, wherein the storage area manager is configured to allocate the same number of memory devices to each of the super block groups.

3. The memory controller of claim 2, wherein the storage area manager is configured to allocate a preset number of memory devices to each of the super block groups.

4. The memory controller of claim 1, wherein the storage area manager is configured to provide a device identification command to the at least one memory device, and obtain information indicating the number of memory devices connected to the one channel from the at least one memory device.

5. The memory controller of claim 1, wherein the operation controller is configured to control the at least one memory device in each of the super block groups to store data in a stripe included in the super block or to read data stored in the stripe.

6. The memory controller of claim 1, further comprising:
a bad block manager configured to generate bad block management information including state information indicating whether the super block is either a normal block or a bad block.

7. The memory controller of claim 6, wherein, upon generation of a bad block management information indicative of a bad block among the at least two memory blocks allocated as the super block, the bad block manager is configured to update the state information of the super block from the normal block to the bad block.

8. The memory controller of claim 1, wherein the at least two memory blocks belong to different memory devices included in each of the super block groups.

9. The memory controller of claim 1, wherein each of the one or more memory devices includes one or more planes, and
the at least two memory blocks belong to different planes included in each of the super block groups.

10. A storage device comprising:
one or more memory devices, each including one or more memory blocks; and
a memory controller in communication with the one or more memory devices through a channel and configured to determine a number of super block groups having a predetermined size based on a number of the one or more memory devices, allocate at least one memory device to each of the super block groups, allocate at least two memory blocks included in the at least one memory device in each of the super block groups as a super block, and control the memory devices to store data in the super block or to read data stored in the super block.

11. The storage device of claim 10, wherein the memory controller is configured to allocate a preset number of memory devices to each of the super block groups having the default size.

12. The storage device of claim 10, wherein the memory controller is configured to provide a device identification command to the at least one memory device and obtain memory die stack information indicating a number of a plurality of memory dies connected to the channel from the at least one memory device.

13. The storage device of claim 10, wherein the memory controller is configured to control the at least one memory device in each of the super block groups to store data in a stripe included in the super block or to read data stored in the stripe.

14. The storage device of claim 10, wherein the at least two memory blocks belong to different memory devices.

15. The storage device of claim 10, wherein each of the one or more memory devices includes one or more planes, and
the at least two memory blocks belong to different planes included in each of the super block groups.

16. A method of operating a storage device including one or more memory devices, comprising:
determining a number of super block groups having a predetermined size based on a number of memory devices connected to a channel;
allocating at least one memory device among the one or more memory devices to each of the super block groups;
allocating at least two memory blocks among memory blocks included in the one or more memory devices of each of the super block groups as a super block; and
performing a read operation or a write operation on the super block.

17. The method of claim 16, wherein allocating the at least one memory device comprises allocating a preset number of memory devices to each of the super block groups having the default size.

18. The method of claim 16, wherein performing the read operation or the write operation comprises storing data in a stripe or reading data stored in the stripe.

19. The method of claim 16, wherein the at least two memory blocks belong to different memory devices.

20. The method of claim 16, wherein each of the one or more memory devices includes one or more planes, and
the at least two memory blocks belong to different planes included in each of the super block groups.
